(19) United States
(12) Patent Application Publication
(10) Pub. No.: US 2012/0189864 A1
(43) Pub. Date: Jul. 26, 2012

(54) COATING AND CAST-IN COMPONENT

(75) Inventor: Gerhard BUCHER, Eppingen (DE)

(73) Assignee: MAHLE INTERNATIONAL GMBH, Stuttgart (DE)

(21) Appl. No.: 13/325,521

(22) Filed: Dec. 14, 2011

(30) Foreign Application Priority Data
Dec. 18, 2010 (DE) 10 2010 055 162.7

(51) Int. Cl. B32B 15/01; B32B 3/30; B32B 3/10; C25D 7/00; B32B 5/00

(52) U.S. Cl. 428/609; 205/50; 428/680; 428/612; 428/679

(57) ABSTRACT

The present invention relates to a coating composed of a metallic coating material, for a cast-in component composed of a metallic material. It is provided, according to the invention, that the coating consists of galvanically applied nickel. The present invention furthermore relates to a cast-in component composed of a metallic material that is coated on at least part of its surface with a coating composed of a metallic coating material, wherein a coating in the form of a galvanically applied nickel layer is provided.

The present, invention relates to a coating composed of a metallic coating material, for a cast-in component composed of a metallic material. The present invention furthermore relates to a cast-in component that is coated on at least part of its surface.

In machine construction, in particular, components frequently have to be provided with a coating that can fulfill various tasks, for example as a tribological coating or as a connection layer between two components. An example is the production of cast parts composed of metals or metal alloys, in which other components, namely cast-in components, composed of a metallic material that differs from that of the cast part, are cast in. This relates, for example, to cast parts composed of light-metal alloys, in the form of crankcases for internal combustion engines. Cylinder liners are cast into these crankcases, which liners generally consist of iron casting materials, steels, or tribologically suitable light-metal alloys, for example having a high silicon content and/or intermetallic phases. Another example is a hoop composed of steel or cast iron, which is cast into a brake drum composed of a light-metal alloy.

In this connection, a firm bond between the material of the cast-in component and the material of the cast part is required, in order to ensure sufficient mechanical anchoring of the cast-in component in the cast part and good heat transfer between the cast-in component and the cast part. However, the materials used for the cast-in component and the cast part, respectively, are generally incompatible and do not form a firm bond with one another. For this reason, the cast-in component is generally provided with a coating on its surface that stands in contact with the cast part, which coating adheres well to the cast-in component, for one thing, and allows an alloy connection to be formed by the material of the cast part.

Frequently, thermally spray-coated layers are used as coatings, not only for cast-in components, but also for other components; these layers are applied to the surface of the component by means of one of the known spray-coating methods (for example wire flame spray-coating, powder flame spray-coating, arc wire spray-coating, plasma spray-coating, HVOF spray-coating, cold gas spray-coating, and more). Such a coating is described in DE 10 2005 027 828 A1, for example.

However, all the thermal spray-coating processes have in common that the thermally spray-coated layers adhere to the component solely on the basis of physical bonds. Thermally spray-coated layers are furthermore generally not free of embedded oxides and porosities. All this is expressed in the adhesion tensile strength of thermally spray-coated layers, which is determined using the adhesion tensile test and generally lies in the range of 10 to 50 N/mm², depending on the material and production quality (in the case of wire flame spray-coating and arc wire spray-coating, generally at 10 to 30 N/mm²). There is therefore the risk that the thermally spray-coated layer tears off under great stress. Because of the great investment requirement for thermal spray-coating and process monitoring, thermally spray-coated layers represent a cost-intensive solution.

Coatings are also known that are obtained by means of dipping the component to be coated into a zinc or zinc-based alloy melt. In this connection, an immersion layer is generally formed, which adheres with sufficient strength after it hardens. However, these coatings are not reliably suited for cast-in components, because the layer can come loose from the cast-in component during the casting-in process, on the basis of the thermal expansion of the zinc, and furthermore, it is weakened at the boundary region to the cast-in material, by means of a pore seam composed of Kirkendall pores.

The present invention is therefore based on the task of making available a coating for a cast-in component as well as a cast-in component that is coated on at least part of its surface, whereby a firm bond between the coating obtained and the component, particularly a good adhesion tensile strength, is supposed to be achievable in cost-advantageous manner.

The solution consists of a coating that consists of galvanically applied nickel, and in a cast-in component that is provided with a coating in the form of a galvanically applied nickel layer on at least part of its surface.

The coating according to the invention and the cast-in component according to the invention are characterized in that a firm bond between the surface of the cast-in component and the coating is produced in particularly simple and cost-advantageous manner. Nickel bonds easily to other metallic materials. It alloys with cast iron, for example, and forms a connection system with aluminum and its alloys. The thermal expansion coefficient of nickel amounts to 13.3×10⁻⁶ K⁻¹, and therefore lies between the values for cast iron (12.0×10⁻⁶ K⁻¹) and aluminum block alloys (21.0×10⁻⁶ K⁻¹). Despite these differences, which still exist, no weakening of the bond between the galvanically applied nickel layer and the cast-in component needs to be feared on the basis of thermal expansion of the coated cast-in component, during the casting-in process.

The coating according to the invention therefore adheres to the cast-in component much more firmly than thermally spray-coated layers. Furthermore, any desired metallic materials can be used for the cast-in component, because the galvanically applied nickel layer can form intermetallic bonds or alloys with the material of the cast-in component.

The cast-in component according to the invention can be processed further in usual manner, and is suitable for many purposes. It can be cast into another cast part, for example, in a manner known to a person skilled in the art, by means of gravity casting, low-pressure casting, die-casting, squeeze casting. If necessary, the component coated according to the invention can be preheated.

Advantageous further developments are evident from the dependent claims.

A layer thickness of 3 μm to 80 μm has proven to be practical. Layer thicknesses of 5 μm to 50 μm are preferred, with which a satisfactory balance between good shear strength and low material consumption is achieved. A layer thickness of 15 μm is particularly preferred.

Depending on the area of application, the coating according to the invention can furthermore contain solids dispersed in it, such as, for example, reinforcement fibers composed of metal or plastic or pyrogenic silicas. In this way, the stability of the coating according to the invention can be further increased. Finally, a thin copper layer can also be galvanically deposited between the surface of the cast-in component and the coating according to the invention.

The coating according to the invention can be applied to surfaces having a broad spectrum of properties, and therefore can be used in particularly versatile manner. For example, surfaces having a rough depth of 5 μm to 1,400 μm are suitable. The surfaces can be cast in finished form or pre-machined by cutting them. The surfaces can also be blasted before the coating according to the invention is applied, for example with abrasives such as glass beads, corundum sand, or steel grit.

The cast-in component can consist, for example, of steel or cast iron, malleable cast iron, or a light-metal alloy such as, for example, an aluminum-based or magnesium-based alloy. The cast-in component can be formed originally by means of casting, forging, rolling, or by way of powder metallurgy. Typical examples of materials that are suitable for the cast-in component are aluminum alloys having up to 30 wt.-% silicon and/or up to 4 wt.-% copper and/or up to 4 wt.-% magnesium and/or up to 4 wt.-% nickel; aluminum-zinc alloys or copper-aluminum-nickel alloys (aluminum bronze); copper-tin alloys having up to 14 wt.-% tin (cast tin bronze); copper-zinc alloys having up to 44 wt.-% zinc; copper-nickel alloys or copper-nickel-iron alloy; steel from the group of the highly alloyed austenitic or ferritic steels; alloys on the basis of titanium.

A typical example of use of the present invention is cylinder liners that are provided with the coating according to the invention and cast into a crankcase of an engine block. Another example is hoops that are provided with the coating according to the invention and cast into a brake drum, or furthermore for ring carriers that are cast into a piston.

Exemplary embodiments of the present invention will be explained in greater detail below.

A component is provided with a coating on its surface. The component can have any desired shape, for example flat, ring-shaped, non-uniform, etc. Examples area cylinder liner for an internal combustion engine, or a hoop for a brake drum. Before being coated, the surface of the component can be cleaned with corundum sand, for example. The surface can be cast in finished manner and be comparatively smooth. However, the surface can also be pre-machined by cutting, or roughened, for example produced using the rough-casting method.

To prepare the coating, a smoothly lathed cylinder liner for the crankcase of an internal combustion engine composed of cast iron was closed off with screw-on plastic caps, in order to prevent deposition of nickel in the liner interior. The current contact can also be passed out of the cylinder liner by way of the screw connection. The outer mantle surface as well as the face surfaces, on the head side and foot side, of the cylinder liner were first degreased using ultrasound, and then anodically degreased. After each work step, etching took place, and rinsing took place multiple times. This method of preparation is familiar to a person skilled in the art.

The coating according to the invention can be applied in the form of a matte nickel plating or a shiny nickel plating, whereby the less complicated matte nickel plating is completely sufficient. Nickel sulfate in aqueous solution was used as an electrolyte, as the main component, for example on the basis of the Watt nickel electrolyte. If necessary, solids can also be contained in it, such as reinforcement fibers or pyrogenic silicas, which disperse into the coating that forms during the production process.

The layer thickness of the coating according to the invention is controlled in known manner, by way of the parameters current density, bath temperature, and pH of the electrolyte. Deposition rates of 1.0 μm to 1.4 μm per minute have proven themselves. A typical deposition rate of 1.2 μm per Minute for the cylinder liner coated in the exemplary embodiment is obtained, for example, at a current density of 6 A/dm², a bath temperature of 60° C., and a pH of the electrolyte of 2.5 to 3.0. It is practical if the electrode is configured in such a manner that it surrounds the cylinder liner in the form of a cylinder mantle, in order to achieve a particularly uniform coating.

The finished, coated cylinder liner was cast into a crankcase. The material of the crankcase was a block alloy of the AlSi8Cu3 type. Before being cast in, the cylinder liner according to the invention was heated to approximately 100° C., for practical reasons, particularly in order to remove traces of moisture.

The good adhesion of the coating according to the invention on the cast-in component is expressed, among other things, in the shear strength, whereby the cylinder liner galvanically coated with nickel on the outer mantle surface, according to the invention, already yielded values of 50 N/mm² when cast into the crankcase, using gravity casting.

1. Coating composed of a metallic coating material, for a cast-in component composed of a metallic material, wherein the coating consists of galvanically applied nickel.

2. Coating according to claim 1, wherein it has a layer thickness of 3 μm to 80 μm, preferably 5 μm to 50 μm, particularly preferably 15 μm.

3. Coating according to claim 1, wherein it furthermore contains dispersed solids.

4. Cast-in component composed of a metallic material, which is provided with a coating composed of a metallic coating material on at least part of its surface, wherein a coating in the form of a galvanically applied nickel layer is provided.

5. Cast-in component according to claim 4, wherein the coating has a layer thickness of 3 μm to 80 μm, preferably 5 μm to 50 μm, particularly preferably 15 μm.

6. Cast-in component according to claim 4, wherein the coating furthermore contains solids dispersed in it and/or a galvanically deposited carrier layer composed of copper.

7. Cast-in component according to claim 4, wherein the coating is applied to a surface region having a rough depth of 5 μm to 1,400 μm.

8. Cast-in component according to claim 4, wherein the coating is applied to a surface region that has been cast in finished manner or pre-machined by cutting.

9. Cast-in component according to claim 4, wherein the coating is applied to a blasted surface region.

10. Cast-in component according to claim 4, wherein it consists of steel or cast iron or a light-metal alloy.

11. Cast-in component according to claim 4, namely a cylinder liner, particularly for being cast into a crankcase of an engine block.

12. Cast-in component according to claim 4, namely a hoop for being cast into a brake drum or a ring carrier for being cast into a piston of an internal combustion engine.

13. Component consisting of a cast part and a cast-in part according to claim 4, around which the cast part is cast.

14. Component according to claim 13, namely a crankcase of an engine block, having cast-in cylinder liners.

15. Component according to claim 13, namely a brake drum having a cast-in hoop.
